(19) United States
(12) Patent Application Publication
(10) Pub. No.: US 2026/0036808 A1
(43) Pub. Date: Feb. 5, 2026

(54) OFF-AXIS OPTICAL SYSTEM AND LIDAR

(71) Applicant: SUTENG INNOVATION TECHNOLOGY CO., LTD., Shenzhen (CN)

(72) Inventors: Bingxuan MAO, Shenzhen (CN); Junting DONG, Shenzhen (CN); Ying YANG, Shenzhen (CN)

(73) Assignee: SUTENG INNOVATION TECHNOLOGY CO., LTD., Shenzhen (CN)

(21) Appl. No.: 19/274,623

(22) Filed: Jul. 20, 2025

(30) Foreign Application Priority Data
Jul. 31, 2024 (CN) 202411045844.8

(51) Int. Cl. G02B 27/00; G01S 7/481

(52) U.S. Cl. CPC G02B 27/0025; G01S 7/4811

(57) ABSTRACT

This application discloses an off-axis optical system and a LiDAR. The off-axis optical system includes a transmitting module, a receiving module, and a deflecting element. The transmitting module and the receiving module are arranged along a first direction perpendicular to the optical axis of the receiving module. The deflecting element is positioned on a light-incident side of the receiving module, with a gap existing along the first direction between the deflecting element and the optical axis of the receiving module. At least part of echo beams, which are formed by reflection of scanning beams emitted from the transmitting module off a target, are refracted by the deflecting element before reaching the receiving module.

### CROSS-REFERENCE TO RELATED APPLICATION

The present application claims the benefit of priority to Chinese Patent Application No. 202411045844.8, filed on Jul. 31, 2024, which is hereby incorporated by reference in its entirety.

### TECHNICAL FIELD

The present application pertains to the field of LiDAR technology and particularly relates to an off-axis optical system and a LiDAR.

### BACKGROUND

LiDAR is a precision instrument that utilizes laser pulses for ranging and perception, and has been widely applied in fields such as autonomous driving, industrial surveying, robotics, and intelligent transportation. LiDAR typically employs an off-axis optical system for transmitting and receiving laser beams. Unlike traditional telescopic systems, in automotive applications, LiDAR must scan both distant targets and detect close-range targets (e.g., vehicles, pedestrians, or road barriers). The positional disparity between the transmitting and receiving modules causes pixel shift in the image actually received by the receiving unit. The closer the target is to the LiDAR, the larger the pixel shift, resulting in incomplete reception of echo beams by the sensor and compromising the detection accuracy of the LiDAR.

### SUMMARY

To enhance the detection accuracy of LiDAR, embodiments of the present application disclose an off-axis optical system and a LiDAR.

In a first aspect, embodiments of the present application disclose an off-axis optical system, including: a transmitting module, a receiving module, and a deflecting element. The transmitting module and the receiving module are arranged along a first direction, and the first direction is perpendicular to an optical axis of the receiving module. The deflecting element is located on a light-incident side of the receiving module, where a gap exists along the first direction between the deflecting element and the optical axis of the receiving module. At least part of echo beams is refracted by the deflecting element to reach the receiving module, and the echo beams are formed by reflection of scanning beams emitted by the transmitting module off a target object.

In some embodiments, the receiving module includes a receiving lens and a receiving unit. The receiving lens is located between the receiving unit and the deflecting element. A sum of a length of the gap along the first direction and a length of the deflecting element along the first direction is a first length, and half of a length of the receiving lens along the first direction is a second length, where the first length is less than or equal to the second length. By setting the deflecting element deviated from the optical axis of the receiving module while ensuring at least part of the echo beams from close-range targets can be refracted by the deflecting element to reach the light-incident surface of the receiving lens.

In some embodiments, a length of the deflecting element along a second direction is greater than or equal to a length of the receiving lens along the second direction. The second direction is perpendicular to the first direction, and the second direction is perpendicular to the optical axis of the receiving module. The first direction corresponds to the horizontal field-of-view direction, and the third direction corresponds to the vertical field-of-view direction. By setting the length of the deflecting element along the third direction to be greater than or equal to that of the receiving lens along the third direction, the deflecting element can deflect echo beams from close-range targets at different vertical fields of view, effectively resolving pixel shift issues for close-range targets at various azimuths.

In some embodiments, the deflecting element includes a first end surface, a second end surface, and a plurality of side surfaces connected between the first end surface and the second end surface. The plurality of side surfaces includes a first side surface, a second side surface, a third side surface, and a fourth side surface. The second side surface is located between the first side surface and the third side surface, the fourth side surface is located between the first side surface and the third side surface, the second side surface is perpendicular to the first direction, and the fourth side surface is perpendicular to the first direction. The at least part of echo beams passes through the first side surface and the third side surface sequentially to reach the receiving lens. A normal of the first side surface is parallel to the optical axis of the receiving module, and an angle between a normal of the third side surface and the optical axis of the receiving module is less than 90 degrees. The deflecting element is a wedge prism. By configuring the wedge prism to deflect at least part of the echo beams (all or partial echo beams from close-range targets), offset correction for echo beams of close-range targets is achieved.

In some embodiments, a distance between the second side surface and the optical axis of the receiving module is less than a distance between the fourth side surface and the optical axis of the receiving module. An included angle between the second side surface and the third side surface is greater than 90 degrees, and an included angle between the fourth side surface and the third side surface is less than 90 degrees.

In some embodiments, a distance between the second side surface and the optical axis of the receiving module is greater than a distance between the fourth side surface and the optical axis of the receiving module. An included angle between the second side surface and the third side surface is less than 90 degrees, and an included angle between the fourth side surface and the third side surface is greater than 90 degrees.

In some embodiments, the deflecting element includes a first prism and a second prism, each prism including a first end surface, a second end surface, and a plurality of side surfaces connected between the first end surface and the second end surface. The plurality of side surfaces includes a first side surface, a second side surface, and a third side surface. The at least part of echo beams passes through the first side surface of the first prism, the third side surface of the first prism, the third side surface of the second prism, and the second side surface of the second prism sequentially to reach the receiving lens, where a normal of the first side surface of the first prism is parallel to the optical axis of the receiving module, the third side surface of the first prism abuts against the third side surface of the second prism, and a normal of the second side surface of the second prism is parallel to the optical axis of the receiving module.

In some embodiments, the receiving module further includes an optical filter, and the optical filter is located between the receiving lens and the receiving unit.

In some embodiments, the optical filter includes a first end surface, a second end surface, and a plurality of side surfaces connected between the first end surface and the second end surface. The plurality of side surfaces include a first side surface, a second side surface, a third side surface, and a fourth side surface, where the second side surface is located between the first side surface and the third side surface, the fourth side surface is located between the first side surface and the third side surface, a normal of the third side surface is parallel to the optical axis of the receiving module, and the fourth side surface is perpendicular to the first direction. The at least part of echo beams passes through the first side surface and the second side surface sequentially to reach the receiving unit, where a normal of the first side surface is parallel to the optical axis of the receiving module, and an included angle between the second side surface and the first side surface is 45 degrees.

In a second aspect, the present application discloses a LiDAR, including a processor and an off-axis optical system. The off-axis optical system includes a transmitting module, a receiving module, and a deflecting element. The transmitting module and the receiving module are arranged along a first direction perpendicular to an optical axis of the receiving module. The deflecting element is located on a light-incident side of the receiving module. A gap exists along the first direction between the deflecting element and the optical axis of the receiving module, and at least part of echo beams is refracted by the deflecting element to reach the receiving module. The echo beams are formed by reflection of scanning beams emitted by the transmitting module off a target object.

Embodiments of the present application disclose an off-axis optical system. The system adds a deflecting element on the receiving side to deflect echo beams from close-range targets, where the deflecting element is positioned according to a predetermined spatial orientation of the transceiver module. The system effectively addresses pixel shift issues in the received image, enhances the reception of echo beams from close-range targets by the LiDAR, and improves the detection accuracy of the LiDAR for close-range targets.

### BRIEF DESCRIPTION OF DRA WINGS

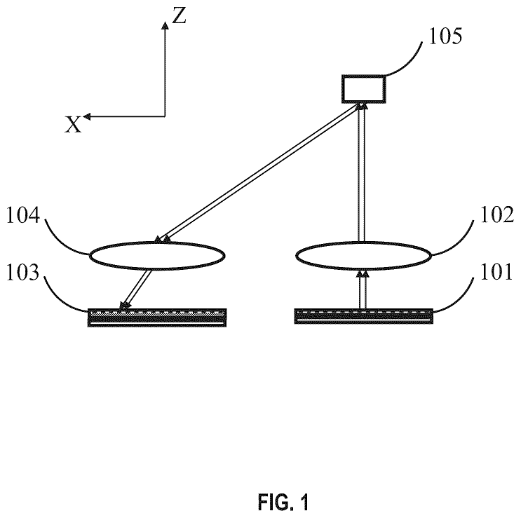

FIG. 1 is a schematic diagram of an off-axis optical system according to an embodiment of the present application;

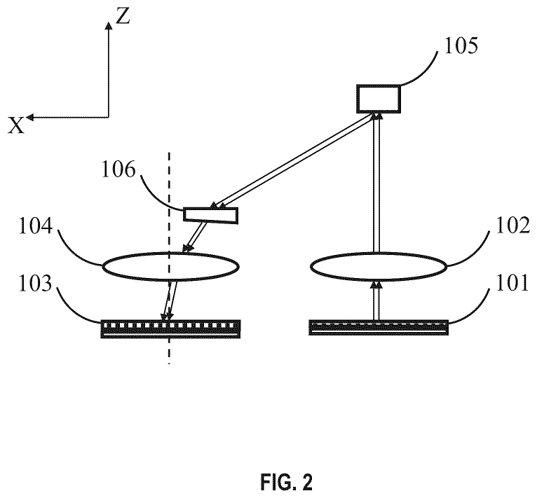

FIG. 2 is a schematic diagram of an off-axis optical system according to an embodiment of the present application;

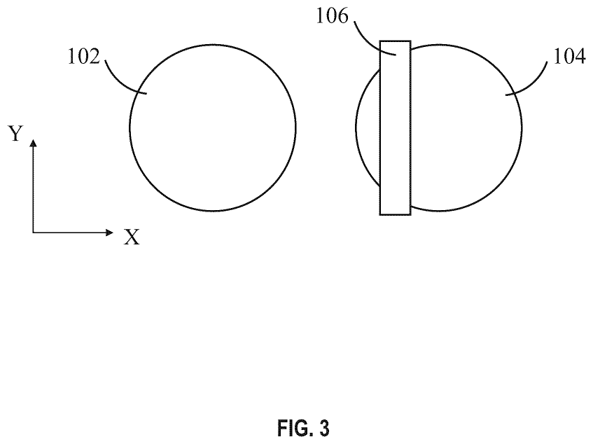

FIG. 3 is a schematic diagram of an off-axis optical system according to an embodiment of the present application;

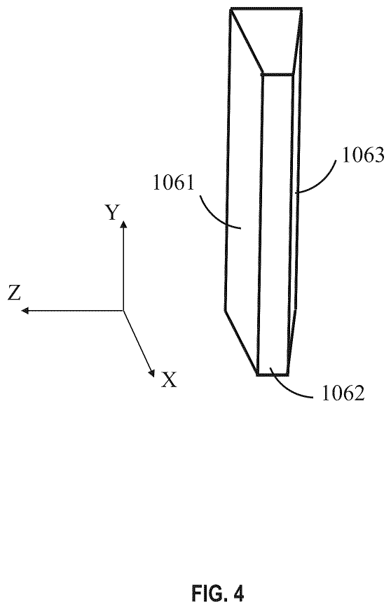

FIG. 4 is a schematic diagram of a deflecting element according to an embodiment of the present application;

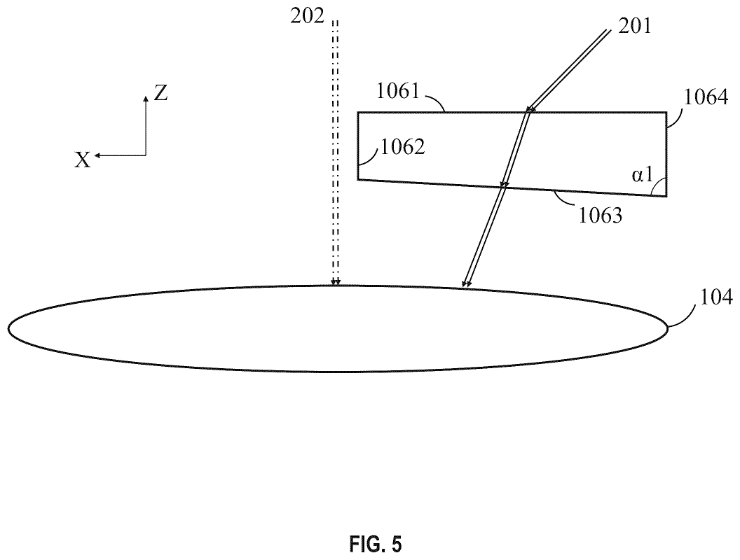

FIG. 5 is a schematic diagram illustrating a positional relationship between a deflecting element and a receiving lens according to an embodiment of the present application;

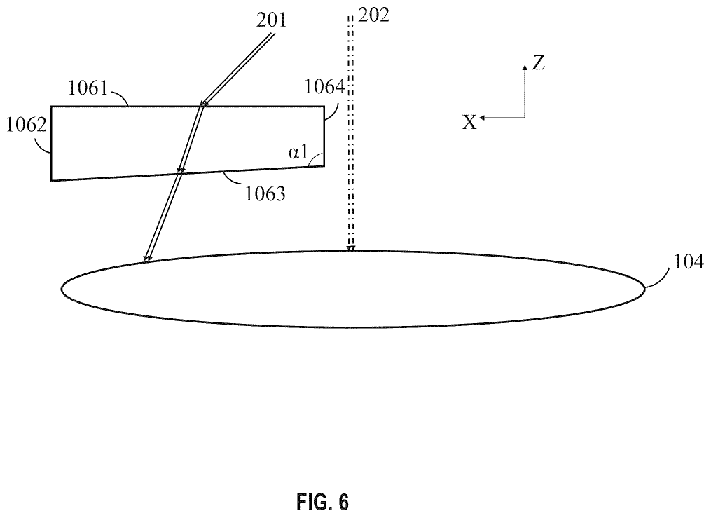

FIG. 6 is a schematic diagram illustrating a positional relationship between a deflecting element and a receiving lens according to an embodiment of the present application;

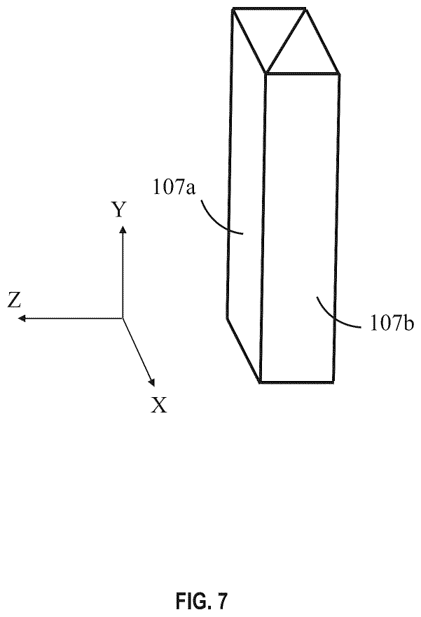

FIG. 7 is a schematic diagram of a deflecting element according to an embodiment of the present application;

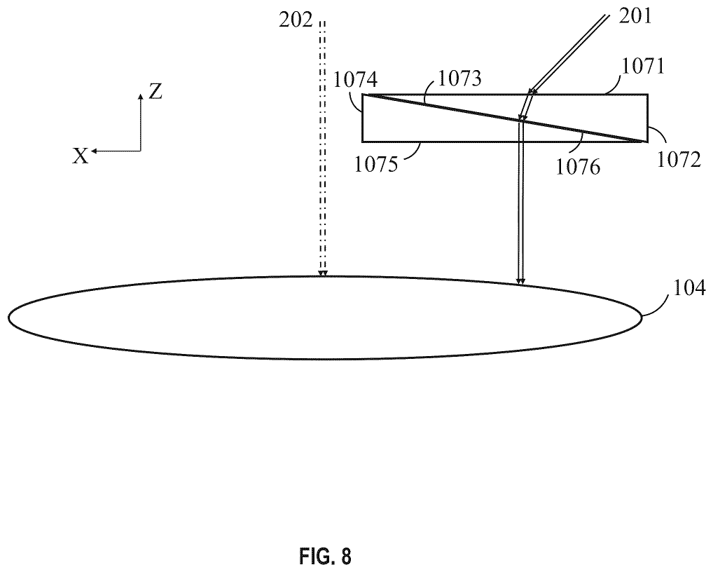

FIG. 8 is a schematic diagram illustrating a positional relationship between a deflecting element and a receiving lens according to an embodiment of the present application;

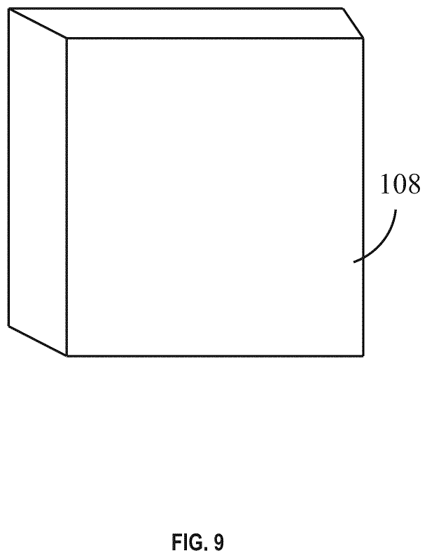

FIG. 9 is a schematic diagram of an optical filter according to an embodiment of the present application;

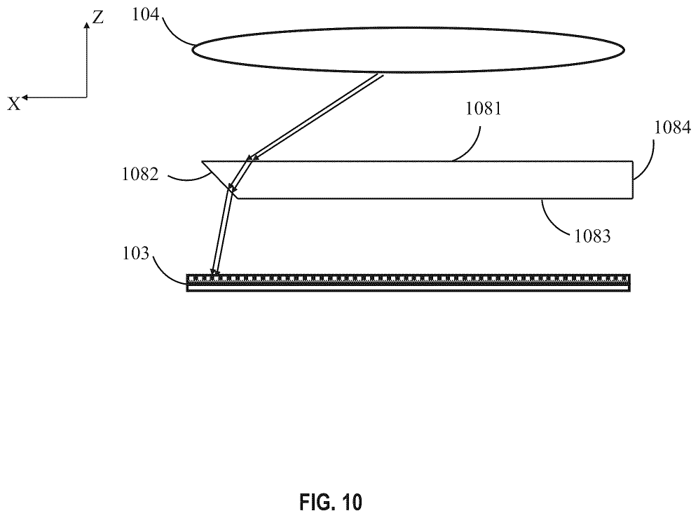

FIG. 10 is a schematic diagram of a receiving module according to an embodiment of the present application; and

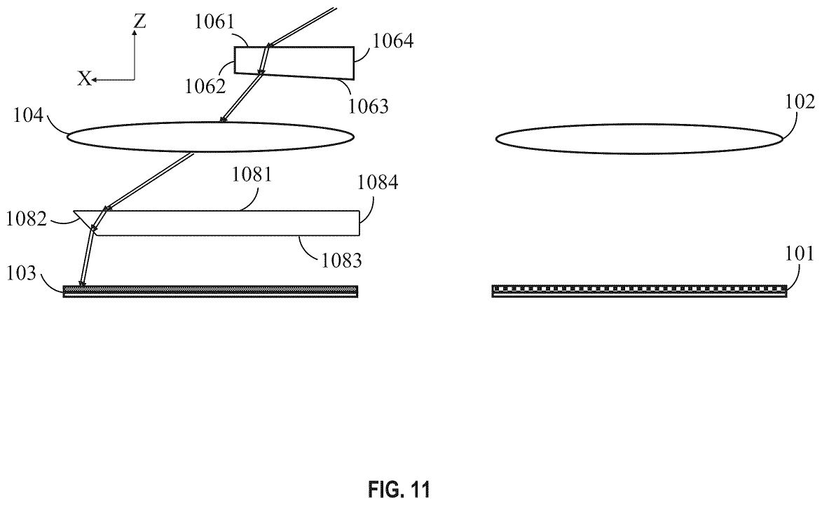

FIG. 11 is a schematic diagram of an off-axis optical system according to an embodiment of the present application.

### DETAILED DESCRIPTION

To make the objectives, technical solutions, and advantages of the present application clearer, the embodiments of the present application will be further described in detail below with reference to the accompanying drawings. When the description below refers to the drawings, unless otherwise indicated, the same numerals in different drawings denote the same or similar elements. The implementation manners described in the following exemplary embodiments do not represent all implementations consistent with the present application. Rather, they are merely examples of structures consistent with some aspects of the present application as detailed in the appended claims.

LiDAR typically scans targets at various distances based on an off-axis optical system, where the off-axis arrangement between the transmitting and receiving modules causes pixel shift issues in the received image. The closer the target is to the LiDAR, the larger the pixel shift, resulting in incomplete reception of echo beams by the sensor and compromising the LiDAR's detection accuracy for close-range targets.

In an embodiment, the off-axis optical system of the LiDAR includes a receiving module and a transmitting module, where the transmitting module emits scanning beams toward a target object, and the receiving module receives echo beams formed by reflection of the scanning beams off the target object. As shown in FIG. 1, a three-dimensional coordinate system is established with an arbitrary point in space as the origin O. The receiving module and the transmitting module are spaced apart along a first direction (X-axis direction). The transmitting module includes a transmitting unit 101 and a transmitting lens 102 spaced apart along the optical axis direction (Z-axis direction) of the transmitting module, while the receiving module includes a receiving unit 103 and a receiving lens 104 spaced apart along the optical axis direction (Z-axis direction) of the receiving module.

The optical axis of the transmitting lens 102 coincides with the optical axis of the transmitting module, and the optical axis of the receiving lens 104 coincides with the optical axis of the receiving module. The optical axis of the transmitting lens 102 is parallel to the Z-axis, and the optical axis of the receiving lens 104 is parallel to the Z-axis. The focal plane of the receiving lens 104 and the focal plane of the transmitting lens 102 are both parallel to the XOY plane. The light-emitting surface of the transmitting unit 101 is located near the focal plane of the transmitting lens 102, and the photosensitive surface of the receiving unit 103 is located near the focal plane of the receiving lens 104. The photosensitive surface of the receiving unit 103 is parallel to the focal plane of the receiving lens 104, and the light-emitting surface of the transmitting unit 101 is parallel to the focal plane of the transmitting lens 102.

In an embodiment, as shown in FIG. 1, scanning beams are emitted from the center of the light-emitting surface of the transmitting unit 101, transmitted through the transmitting lens 102, and reach the surface of the target object 105. The surface of the target object 105 reflects the scanning beams to form echo beams, which are deflected by the receiving lens 104 and reach the photosensitive surface of the receiving unit 103. For a distant target, since the detection distance is much greater than the baseline distance (i.e., the distance between the optical axis of the transmitting lens 102 and the optical axis of the receiving lens 104, or the distance between the optical center of the transmitting lens 102 and the optical center of the receiving lens 104), the incident angle of the echo beams from distant targets on the surface of the receiving lens 104 approaches zero degrees. For close-range targets, however, the shift of echo beams caused by the baseline distance must be considered, as the echo beams from close-range targets obliquely incident on the surface of the receiving lens 104. This results in the actual imaging position of a close-range target on the photosensitive surface being farther from the center of the photosensitive surface of the receiving unit 103 compared to that of a distant target.

Targets at different detection distances correspond to different image-space incident angles (i.e., the angle between the echo beam and the optical axis of the receiving module). The closer the detection distance of the target, the larger the image-space incident angle and the greater the pixel shift value, where the pixel shift value is the distance between the actual imaging position of the target and the center of the photosensitive surface of the receiving unit 103. For close-range targets, when the pixel shift value is large, part of the echo beams may fail to reach the photosensitive surface of the receiving unit 103, affecting the actual received echo energy by the receiving unit 103 and thereby compromising the detection accuracy of the LiDAR.

In an embodiment, to address the pixel shift issue for close-range targets, the present application discloses an off-axis optical system for LiDAR. This system deflects at least part of the echo beams (i.e., at least a portion of the echo beams from close-range targets) using a deflecting element, enabling the portion to reach the photosensitive surface of the receiving unit 103. In an example, as shown in FIG. 2, based on the off-axis optical system in FIG. 1, a deflecting element 106 is added. Here, the deflecting element 106 is positioned on the light-incident side of the receiving lens 104, with the deflecting element 106, receiving lens 104, and receiving unit 103 spaced apart sequentially along the Z-axis direction. A gap exists along the X-axis direction between the deflecting element 106 and the optical axis of the receiving module. This configuration effectively corrects echo beams from the close-range target object 105 while preventing obstruction of the incident paraxial echo beams (corresponding to echo beams from distant targets). Before reaching the surface of the receiving lens 104, at least part of the echo beams formed by reflection off the close-range target object 105 are deflected by the deflecting element 106. This reduces the incident angle or incident distance on the surface of the receiving lens 104, thereby decreasing the pixel shift value for the close-range targets and achieving offset correction for its echo beams. The incident distance refers to the distance along the light-incident surface of the receiving lens 104 between the incident position of the echo beams from the close-range target object 105 and the optical axis of the receiving lens 104.

In an embodiment, the sum of the length of the gap along the X-axis direction and the length of the deflecting element 106 along the X-axis direction constitutes a first length. Half of the length of the receiving lens 104 along the X-axis direction constitutes a second length, where the first length is less than or equal to the second length. This size relationship constrains the relative positional relationship between the deflecting element 106 and the receiving lens 104 along the X-axis, ensuring that in the X-axis direction, the deflecting element 106 is positioned between the optical axis of the receiving lens 104 and its edge. This ensures that paraxial echo beams remain unobstructed while guaranteeing that at least part of the echo beams from close-range targets can be refracted by the deflecting element 106 to reach the light-incident surface of the receiving lens 104.

As shown in FIG. 3, the deflecting element 106 is symmetrically arranged relative to the X-axis direction, and the receiving lens 104 is also symmetrically arranged relative to the X-axis direction. The length of the deflecting element 106 along a second direction (Y-axis direction) is greater than that of the receiving lens 104 along the same second direction. Here, the first direction corresponds to the horizontal field-of-view direction of the LiDAR, and the second direction corresponds to its vertical field-of-view direction. This enables correction of echo beams from close-range targets across different vertical fields of view.

In some embodiments, the deflecting element 106 is a transmissive optical element with beam-deflecting capability, such as a prism, transmission grating, or lens. It corrects the pixel shift value of echo beams from close-range targets, enhances the effective signal strength received by the receiving unit 103, and improves the LiDAR's detection accuracy for close-range targets. Compared to reflective elements like planar mirrors, transmissive elements such as prisms, gratings, or lenses do not obstruct the optical path. They maintain the intensity of echo beams from close-range targets while minimizing obstruction of echo beams from distant targets.

In an embodiment, the deflecting element 106 is a wedge prism. This wedge prism includes a first end surface, a second end surface, and multiple side surfaces connected between them. The side surfaces include a first side surface, a second side surface, a third side surface, and a fourth side surface. The second side surface is located between the first and third side surfaces, while the fourth side surface is located between the first and third side surfaces. At least part of the echo beams sequentially pass through the first side surface and the third side surface to reach the receiving lens. Both the first and second end surfaces are perpendicular to the Y-axis direction. The normal of the first side surface is parallel to the optical axis of the receiving module (i.e., the first side surface is perpendicular to the Z-axis direction), and the angle between the normal of the third side surface and the optical axis of the receiving module is less than 90 degrees (yet greater than 0 degrees).

In an embodiment, the wedge prism is positioned between the optical axis of the transmitting module and the optical axis of the receiving module. The side of the wedge prism facing the optical axis of the receiving module is the second side surface, while the side facing the optical axis of the transmitting module is the fourth side surface. The distance between the second side surface and the optical axis of the receiving module is less than the distance between the fourth side surface and the optical axis.

Referring to FIG. 4 and FIG. 5, the multiple side surfaces of the deflecting element 106 include a first side surface 1061, a second side surface 1062, a third side surface 1063, and a fourth side surface 1064. The first side surface 1061 is perpendicular to the Z-axis direction, the second side surface 1062 is perpendicular to the X-axis direction, the angle between the normal of the third side surface 1063 and the Z-axis is a first angle, and the fourth side surface 1064 is perpendicular to the X-axis direction, where the first angle is less than 90 degrees. The off-axis beams 201 (echo beams from the close-range targets) enter through the first side surface 1061 and exit through the third side surface 1063. The included angle between the second side surface 1062 and the third side surface 1063 is greater than 90 degrees, and the included angle α1 between the fourth side surface 1064 and the third side surface 1063 is less than 90 degrees. The projection of the deflecting element 106 in the XOZ plane forms a right-angled trapezoid.

In another embodiment, the wedge prism is located on the light-incident side of the receiving module and positioned on the side of its optical axis away from the transmitting module. The side of the wedge prism facing the optical axis of the receiving module is now the fourth side surface. The distance between the second side surface and the optical axis of the receiving module is greater than that between the fourth side surface and the optical axis. As shown in FIG. 6, the first side surface 1061 is perpendicular to the Z-axis direction, the second side surface 1062 is perpendicular to the X-axis direction, the angle between the normal of the third side surface 1063 and the Z-axis is a first angle, and the fourth side surface 1064 is perpendicular to the X-axis direction (first angle <90°). The off-axis beams 201 (echo beams from the close-range targets) enter through the first side surface 1061 and exit through the third side surface 1063. The included angle between the second side surface 1062 and the third side surface 1063 is less than 90 degrees, while the included angle α1 between the fourth side surface 1064 and the third side surface 1063 is greater than 90 degrees. The projection of the deflecting element 106 in the XOZ plane forms a right-angled trapezoid.

In an embodiment, the setting of the first angle for the wedge prism compensates for the incident angle deviation between echo beams from distant targets and close-range targets. In an embodiment, the refractive index n of the wedge prism exceeds that of air (approximated as 1,within the range of 1.000277 to 1.0003), enabling deflection of echo beams from close-range targets. The detection range of the LiDAR spans from 0.1 m to 100 m. Let the first angle be θ, where θ satisfies: β=θ*(n−1). Here, β=arctan(A/D), A denotes the baseline distance, and D represents the preset blind-spot compensation distance (the shortest detection distance; e.g., D=0.1 m when the detection range is 0.1 m to 100 m). The configuration of the first angle θ corrects the difference in incident angles between the off-axis beams 201 (echo beams from the close-range targets) and paraxial beams 202 (echo beams from distant targets with near-zero incident angles).

In an embodiment, along the X-axis direction, the deflecting element 106 is positioned as close as possible to the edge of the light-passing aperture corresponding to echo beams from distant targets (detection distance: 100 m), while simultaneously lying within the light-passing aperture corresponding to echo beams from close-range targets (detection distance: 0.1 m). This enhances the energy of echo beams from close-range targets while minimizing obstruction of those from distant targets. It should be noted that for different LiDAR systems, the definitions of close-range and distant vary depending on design parameters like detection distance, transceiver lens group specifications, and baseline distance. The aperture corresponding to echo beams reflected from targets at different detection distances also differs. Those skilled in the art will recognize that regardless of the specific model of off-axis optical system-based LiDAR, adding the deflecting element 106 into the transmission path of echo beams from close-range targets can achieve correction for the resulting pixel shift values.

In an embodiment, the deflecting element 106 includes a first prism and a second prism. The first prism 107a and the second prism 107b are one or a combination of triangular prisms, quadrangular prisms, or pentagonal prisms. They deflect at least part of the echo beams from close-range targets without obstructing paraxial echo beams. In an example, referring to FIG. 7 and FIG. 8, each prism is a triangular prism including a first end surface, a second end surface, and multiple side surfaces connected between them. These side surfaces include a first side surface, a second side surface, and a third side surface. At least part of the echo beams sequentially pass through the first side surface of the first prism, the third side surface of the first prism, the third side surface of the second prism, and the second side surface of the second prism to reach the receiving lens. The first prism 107a includes a first side surface 1071, a second side surface 1072, and a third side surface 1073. The second prism 107b includes a first side surface 1074, a second side surface 1075, and a third side surface 1076. The first side surface 1071 of the first prism 107a and the second side surface 1075 of the second prism 107b are both perpendicular to the Z-axis direction. The second side surface 1072 of the first prism 107a and the first side surface 1074 of the second prism 107b are both perpendicular to the X-axis direction. A gap exists along the X-axis direction between the first side surface 1074 of the second prism 107b and the optical axis of the receiving lens 104. The included angle between the first side surface 1071 and the third side surface 1073 of the first prism 107a is a second angle. The included angle between the second side surface 1072 and the third side surface 1073 of the first prism 107a is a third angle. The included angle between the second side surface 1075 and the third side surface 1076 of the second prism 107b is the second angle. The included angle between the first side surface 1074 and the third side surface 1076 of the second prism 107b is the third angle. The third side surface 1073 of the first prism 107a abuts against and is bonded to the third side surface 1076 of the second prism 107b via optical adhesive. The second angle and the third angle are complementary angles. The first side surface 1071 of the first prism 107a is perpendicular to its second side surface 1072. The first side surface 1074 of the second prism 107b is perpendicular to its second side surface 1075. After abutment, the projection of the deflecting element 106 in the XOZ plane forms a rectangle. In another example, the second angle is less than 90 degrees, and the sum of the second angle and the third angle exceeds 90 degrees. After abutment, the projection of the deflecting element 106 in the XOZ plane forms a parallelogram or rhombus.

In some embodiments, the refractive index of the first prism is greater than that of the second prism; or the refractive index of the first prism is less than that of the second prism. By adjusting the refractive indices of the first prism 107a and the second prism 107b, or by adjusting the second and third included angles, the incident angle and incident distance of echo beams from close-range targets on the surface of the receiving lens 104 can be altered, thereby achieving offset correction for the echo beams of close-range targets.

In an embodiment, the refractive index of the first prism 107a is greater than that of air, while the refractive index of the second prism 107b is equal to or approximately equal to that of air. Echo beams from close-range targets refract into the interior of the first prism 107a through its first side surface 1071, then refract at the third side surface 1073 of the first prism 107a to enter the interior of the second prism 107b. Since the refractive index of the second prism 107b matches that of air, no refraction occurs when the echo beams pass through the second side surface 1075 of the second prism 107b. After transmitting through the second side surface 1075, the echo beams reach the light-incident surface of the receiving lens 104. Adjusting the refractive index of the first prism 107a modifies the exit angle of the echo beams at the first side surface 1071. Furthermore, by adjusting the included angle between the second side surface 1072 and third side surface 1073 of the first prism 107a, both the incident and exit angles of the echo beams at the third side surface 1073 can be controlled. This ultimately adjusts the incident angle and distance of the echo beams on the surface of the receiving lens 104.

In another embodiment, the refractive index of the first prism 107a exceeds that of air, while the refractive index of the second prism 107b is either greater or less than that of air. Echo beams refract into the first prism 107a through its first side surface 1071, then refract at the third side surface 1073 to enter the second prism 107b. Finally, they refract again at the second side surface 1075 of the second prism 107b before reaching the surface of the receiving lens 104, achieving offset correction. By jointly adjusting the refractive indices of both prisms and modifying the included angles between: The second and third side surfaces of the first prism 107a The second and third side surfaces of the second prism 107b the incident angle and distance of echo beams on the receiving lens 104 are precisely controlled to correct beam offsets.

In an embodiment, to enhance effective reception of echo beam energy from targets at varying distances, a planar optical filter is positioned between the receiving unit 103 and the receiving lens 104. The planar optical filter adjoins the photosensitive surface of the receiving unit 103, with its length along the X-axis being greater than or equal to that of the receiving unit 103 along the X-axis, and its length along the Y-axis being greater than or equal to that of the receiving unit 103 along the Y-axis. The planar optical filter functions as a narrowband optical filter with filtering wavelength ranges of 900-910 nm, 935-945 nm, or 1540-1560 nm. It filters stray light incident on the photosensitive surface at different angles, blocking ambient light and non-target sources. This reduces background noise, enhances signal-to-noise ratio (SNR), improves measurement accuracy, and boosts the anti-interference capability of the LiDAR.

In an embodiment, to further correct pixel shift issues, an edge-cutting process is applied to the planar optical filter. In an embodiment, referring to FIG. 9 and FIG. 10, the optical filter 108 includes a first end surface, a second end surface, and multiple side surfaces connected between them. The multiple side surfaces of the optical filter 108 include a first side surface 1081, second side surface 1082, third side surface 1083, and fourth side surface 1084. Both end surfaces are perpendicular to the Y-axis direction. At least part of the echo beams sequentially passes through the first side surface 1081 and second side surface 1082 to reach the receiving unit 103.

In an embodiment, as shown in FIG. 10, the second side surface 1082 of the optical filter 108 is an inclined surface, with the included angle between the second side surface 1082 and the first side surface 1081 being less than or equal to 45 degrees. The first side surface 1081 and third side surface 1083 are perpendicular to the Z-axis, while the fourth side surface 1084 is perpendicular to the X-axis. At least part of echo beams from close-range targets refract at the first side surface 1081 of the optical filter 108 and enter the interior of the optical filter 108. These beams then refract again at the second side surface 1082 and reach the photosensitive surface of the receiving unit 103, ensuring all echo beams from close-range targets successfully arrive at the photosensitive surface, thereby mitigating image shift issues for such targets.

In another embodiment, the fourth side surface 1084 is an inclined surface, with the included angle between the fourth side surface 1084 and the first side surface 1081 being less than or equal to 45 degrees. The first side surface 1081 is perpendicular to the Z-axis direction, and the third side surface 1083 is perpendicular to the Z-axis direction, while the second side surface 1082 is perpendicular to the X-axis direction. At least a portion of echo beams from close-range targets refract at the first side surface 1081 of the optical filter 108, enter its interior, and then refract again at the fourth side surface 1084 to reach the photosensitive surface of the receiving unit 103.

In an embodiment, as shown in FIG. 11, the off-axis optical system includes a transmitting module and a receiving module. The transmitting module includes a transmitting unit 101 and a transmitting lens 102 spaced apart along the Z-axis direction. The receiving module includes a receiving unit 103, an optical filter 108, a receiving lens 104, and a deflecting element 106 spaced apart along the Z-axis direction. The deflecting element 106 is a wedge prism positioned on the light-incident side of the receiving module and located on the side of the optical axis of the receiving lens 104 closer to the transmitting lens 102. It performs the first offset correction on at least part of echo beams from close-range targets. The optical filter 108 undergoes edge-cutting on the side away from the transmitting module, with the cut surface being the second side surface 1082 of the optical filter 108. The included angle between the second side surface 1082 and the first side surface 1081 of the optical filter 108 is ≤45 degrees. At least part of the echo beams from close-range targets refract into the interior of the deflecting element 106 through its first side surface 1061, then refract at the third side surface 1063 to reach the light-incident surface of the receiving lens 104. Subsequently, they sequentially pass through the receiving lens 104, refract at the first side surface 1081 and the second side surface 1082 of the optical filter 108, and finally reach the photosensitive surface of the receiving unit 103. Alternatively, after refraction at the third side surface 1063 of the deflecting element 106, the beams may pass through the receiving lens 104, then refract at the first side surface 1081 and the third side surface 1083 of the optical filter 108 before reaching the photosensitive surface. By incorporating the deflecting element 106 and the edge-cut optical filter 108 in the receiving module, effective reception of echo beams from close-range targets is ensured without obstructing paraxial echo beams.

In some embodiments, the receiving module includes multiple receiving lenses 104, each performing functions such as aberration correction, beam reduction, or collimation. In an embodiment, multiple receiving lenses 104 are fixed within a lens barrel. The barrel includes a first aperture and a second aperture arranged along the X-axis direction, the transmitting module is fixed to the first aperture, while the receiving module is fixed to the second aperture. The barrel further includes a first mounting bracket and a second mounting bracket arranged along the Y-axis direction, with the second aperture located between them. The edges of each mounting bracket abut against the edge of the second aperture. One end of the deflecting element 106 is fixed to the first mounting bracket, and the other end to the second mounting bracket, positioning the deflecting element 106 between the optical axis of the transmitting module and that of the receiving module. The deflecting element 106 is secured to the mounting brackets via adhesive bonding or screw fastening. In another example, the deflecting element 106 is positioned between two receiving lenses 104, with mounting brackets located inside the lens barrel. Fixation between the deflecting element 106 and the brackets is achieved through adhesive bonding or screw fastening.

In some embodiments, anti-reflection coatings are applied to optical surfaces such as those of the receiving lens 104 within the receiving module or the deflecting element 106. This enhances the transmittance of laser beams emitted by the transmitting unit 101 across these optical surfaces, thereby improving the utilization efficiency of echo energy. The coating material includes one or a combination of silicon dioxide (SiO₂), aluminum oxide (Al₂O₃), magnesium fluoride (MgF₂), or silicon nitride (Si₃N₄). The anti-reflection coating may be a single-layer dielectric film or a multi-layer dielectric film. For single-layer coatings, the optical thickness is configured based on the emission wavelength of the LiDAR. Multi-layer anti-reflection films consist of one or more materials with differing refractive indices, such as SiO₂, Al₂O₃, MgF₂, or Si₃N₄. By adjusting the thickness and refractive index of each dielectric layer, destructive interference of the laser beam within the multi-layer coating is induced, achieving extinction for specific wavelengths or within a defined wavelength range.

In some embodiments, the LiDAR is one of a mechanical LiDAR, Optical Phased Array (OPA) solid-state LiDAR, Micro-Electro-Mechanical System (MEMS) solid-state LiDAR, or Flash solid-state LiDAR. The LiDAR includes an off-axis optical system and a processor. In one embodiment, the transmitting unit 101 is a surface-emitting array or linear-emitting array, each including multiple Vertical-Cavity Surface-Emitting Lasers (VCSELs) or Edge-Emitting Lasers (EELs). The receiving unit 103 is a SPAD array incorporating multiple Single Photon Avalanche Diodes (SPADs) or a Silicon Photomultiplier (SiPM) linear array. The processor is a Field-Programmable Gate Array (FPGA), System on Chip (SoC), Central Processor Unit (CPU), Network Processor (NP), digital signal processing circuit, Micro Controller Unit (MCU), Application-Specific Integrated Circuit (ASIC), or any combination thereof, configured to implement relevant functionalities.

In the description of this application, it should be understood that unless otherwise defined, all technical and scientific terms used herein have the same meanings as commonly understood by those skilled in the technical field of this application. The terminology used in this specification is for describing specific embodiments only and is not intended to limit the application. The terms “and/or” or “and/or” describe the association relationship of associated objects, indicating three possible relationships—for example, “A and/or B” may denote: A exists alone, both A and B coexist, or B exists alone. The character “/” generally indicates an “or” relationship between the associated objects preceding and succeeding it. The singular forms “a,” “an” are also intended to include plural forms unless the context clearly dictates otherwise. When the terms “comprise” and/or “include” are used in this specification, they specify the presence of stated features, elements, and/or components, but do not preclude the presence or addition of one or more other features, elements, components, and/or combinations thereof—that is, encompassing any and all combinations of one or more related listed items. References in the embodiments of this application to ordinals such as “first” and “second” are merely identifiers and carry no other implications—such as a specific sequence or relative importance.

In this application, unless explicitly specified or defined otherwise, a first feature being “on” or “under” a second feature may include direct contact between the first and second features, or may include indirect contact through additional features between them. Furthermore, the first feature being “on,” “above,” or “over” the second feature includes the first feature being directly above or diagonally above the second feature, or merely indicates that the horizontal level of the first feature is higher than that of the second feature. The first feature being “under,” “below,” or “beneath” the second feature includes the first feature being directly below or diagonally below the second feature, or merely indicates that the horizontal level of the first feature is lower than that of the second feature. Those of ordinary skill in the art may understand the specific meanings of these terms according to specific contexts. The phrase “one or more embodiments” used herein does not refer to identical embodiments but rather denotes combinations of specific features, structures, or characteristics based on any suitable approach. The above descriptions are merely preferred embodiments of this application and are not intended to limit it. Any modifications, equivalent substitutions, or improvements made within the spirit and principles of this application shall be included within its scope of protection.

What is claimed is:

1. An off-axis optical system, comprising a transmitting module, a receiving module, and a deflecting element,
wherein the transmitting module and the receiving module are arranged along a first direction perpendicular to an optical axis of the receiving module; and
the deflecting element is located on a light-incident side of the receiving module, wherein a gap exists along the first direction between the deflecting element and the optical axis of the receiving module, and at least part of echo beams is refracted by the deflecting element to reach the receiving module, wherein the echo beams are formed by reflection of scanning beams emitted by the transmitting module off a target object.

2. The off-axis optical system according to claim 1, wherein the receiving module comprises a receiving lens and a receiving unit, and the receiving lens is located between the receiving unit and the deflecting element,
wherein a sum of a length of the gap along the first direction and a length of the deflecting element along the first direction is a first length, and half of a length of the receiving lens along the first direction is a second length, wherein the first length is less than or equal to the second length.

3. The off-axis optical system according to claim 2, wherein a length of the deflecting element along a second direction is greater than or equal to a length of the receiving lens along the second direction, the second direction is perpendicular to the first direction, and the second direction is perpendicular to the optical axis of the receiving module.

4. The off-axis optical system according to claim 3, wherein the deflecting element comprises a first end surface, a second end surface, and a plurality of side surfaces connected between the first end surface and the second end surface, the plurality of side surfaces comprising a first side surface, a second side surface, a third side surface, and a fourth side surface,
wherein the second side surface is located between the first side surface and the third side surface, the fourth side surface is located between the first side surface and the third side surface, the second side surface is perpendicular to the first direction, and the fourth side surface is perpendicular to the first direction;
wherein the at least part of echo beams passes through the first side surface and the third side surface sequentially to reach the receiving lens; and
wherein a normal of the first side surface is parallel to the optical axis of the receiving module, and an angle between a normal of the third side surface and the optical axis of the receiving module is less than 90 degrees.

5. The off-axis optical system according to claim 4, wherein a distance between the second side surface and the optical axis of the receiving module is less than a distance between the fourth side surface and the optical axis of the receiving module; and
wherein an included angle between the second side surface and the third side surface is greater than 90 degrees, and an included angle between the fourth side surface and the third side surface is less than 90 degrees.

6. The off-axis optical system according to claim 4, wherein a distance between the second side surface and the optical axis of the receiving module is greater than a distance between the fourth side surface and the optical axis of the receiving module; and
wherein an included angle between the second side surface and the third side surface is less than 90 degrees, and an included angle between the fourth side surface and the third side surface is greater than 90 degrees.

7. The off-axis optical system according to claim 3, wherein the deflecting element comprises a first prism and a second prism,
wherein each prism comprises a first end surface, a second end surface, and a plurality of side surfaces connected between the first end surface and the second end surface, the plurality of side surfaces comprising a first side surface, a second side surface, and a third side surface;
wherein the at least part of echo beams passes through the first side surface of the first prism, the third side surface of the first prism, the third side surface of the second prism, and the second side surface of the second prism sequentially to reach the receiving lens; and
wherein a normal of the first side surface of the first prism is parallel to the optical axis of the receiving module, the third side surface of the first prism abuts against the third side surface of the second prism, and a normal of the second side surface of the second prism is parallel to the optical axis of the receiving module.

8. The off-axis optical system according to claim 2, wherein the receiving module further comprises an optical filter, and the optical filter is located between the receiving lens and the receiving unit.

9. The off-axis optical system according to claim 8, wherein the optical filter comprises a first end surface, a second end surface, and a plurality of side surfaces connected between the first end surface and the second end surface, the plurality of side surfaces comprising a first side surface, a second side surface, a third side surface, and a fourth side surface;
wherein the second side surface is located between the first side surface and the third side surface, the fourth side surface is located between the first side surface and the third side surface, a normal of the third side surface is parallel to the optical axis of the receiving module, and the fourth side surface is perpendicular to the first direction;
wherein the at least part of echo beams passes through the first side surface and the second side surface sequentially to reach the receiving unit; and
wherein a normal of the first side surface is parallel to the optical axis of the receiving module, and an included angle between the second side surface and the first side surface is 45 degrees.

10. A LIDAR, comprising a processor and an off-axis optical system, wherein the off-axis optical system comprises a transmitting module, a receiving module, and a deflecting element,
wherein the transmitting module and the receiving module are arranged along a first direction perpendicular to an optical axis of the receiving module; and
wherein the deflecting element is located on a light-incident side of the receiving module, wherein a gap exists along the first direction between the deflecting element and the optical axis of the receiving module, and at least part of echo beams is refracted by the deflecting element to reach the receiving module, wherein the echo beams being formed by reflection of scanning beams emitted by the transmitting module off a target object.
